(19) United States
(12) Patent Application Publication
(10) Pub. No.: US 2014/0090774 A1
(43) Pub. Date: Apr. 3, 2014

(54) MOUNTING SHEET, POLISHING APPARATUS, AND METHOD FOR MAKING THE SAME

(71) Applicant: SAN FANG CHEMICAL INDUSTRY CO., LTD., Kaohsiung City (TW)

(72) Inventors: CHUNG-CHIH FENG, KAOHSIUNG CITY (TW); I-PENG YAO, KAOHSIUNG CITY (TW); LYANG-GUNG WANG, KAOHSIUNG CITY (TW); HSIN-RU SONG, KAOHSIUNG CITY (TW); WEN-CHIEH WU, KAOHSIUNG CITY (TW)

(73) Assignee: SAN FANG CHEMICAL INDUSTRY CO., LTD., Kaohsiung City (TW)

(21) Appl. No.: 14/045,169

(22) Filed: Oct. 3, 2013

(30) Foreign Application Priority Data
Oct. 3, 2012 (TW) 101136439

(51) Int. Cl. B24B 41/06; B23Q 3/10

(52) U.S. Cl. CPC B24B 41/06; B23Q 3/105
USPC 156/230; 269/13; 156/345.12

(57) ABSTRACT

The present invention relates to a mounting sheet comprising a mounting layer. The mounting layer comprises a mounting surface for mounting the substrate. The mounting surface comprises a first mounting area and a second mounting area, and wherein a mounting force of the first mounting area is stronger than a mounting force of the second mounting area. The sheet according to the invention has the different mounting areas, so that the substrate is easily unloaded when polishing is completed. Furthermore, the broken of the substrate due to removal and the duration and the difficulty of removal are reduced.

### BACKGROUND OF THE INVENTION

1. Field of the Invention

The present invention relates to a mounting sheet, a polishing apparatus and a method for making the same. Particularly, the invention relates to a mounting sheet with different mounting areas, a polishing apparatus and a method for making the same.

2. Description of the Related Art

Polishing generally refers to a wear control for a preliminary coarse surface in the process of chemical mechanical polishing, which makes the slurry containing fine particles evenly dispersed on the upper surface of a polishing pad, and at the same time places a polishing workpiece against the polishing pad and then rubs the polishing workpiece repeatedly with a regular motion. The polishing workpiece may be objects such as a semiconductor, a storage medium substrate, an integrated circuit, an LCD flat-panel glass, an optical glass and a photoelectric panel. During the polishing process, a mounting sheet must be used for carrying and mounting the polishing workpiece, and the quality of the mounting sheet directly influences the polishing effect of the polishing workpiece.

FIG. 1 shows a schematic view of a polishing device with a conventional mounting sheet. The polishing device 1 includes a lower base plate 11, a mounting sheet 12, a polishing workpiece 13, an upper base plate 14, a polishing pad 15 and slurry 16. The mounting sheet 12 is adhered to the lower base plate 11 through an adhesive layer 17 and is used for carrying and mounting the polishing workpiece 13. The polishing pad 15 is mounted on the upper base plate 14.

The operation mode of the polishing device 1 is as follows. First, the polishing workpiece 13 is mounted on the mounting sheet 12, and then both the upper and lower base plates 14 and 11 are rotated and the upper base plate 14 is simultaneously moved downward, such that the polishing pad 15 contacts the surface of the polishing workpiece 13, and a polishing operation for the polishing workpiece 13 may be performed by continuously supplementing the slurry 16 and using the effect of the polishing pad 15.

In order to effectively mount and secure the polishing workpiece in the polishing process, a mounting force of the conventional mounting sheet is usually great. Furthermore, a material of a mounting surface of the mounting sheet for mounting the polishing workpiece is usually foamed polyurethane comprising a plurality of foam pores. Air in the foam pores may be removed to form a low-pressure environment by extruding during the polishing process, and the mounting force is further enhanced. After completing the polishing process, the polishing workpiece 13 must be unloaded from the mounting sheet 12. The great mounting force causes resistance in the unloading process. Parts of the polishing workpiece mounted by a peripheral area of the mounting sheet are easily unloaded because machining is easily applied thereon, and a greater moment of force is achieved when applying a constant force. However, parts of the polishing workpiece mounted by an area closer to a center of the mounting sheet are difficultly unloaded because machining is hardly applied thereon, and a less moment of force is achieved when applying a constant force. If the polishing workpiece is a thin panel with a large area such as an optical glass, the duration of the unloading process is extended, and difficulty of the unloading process is high. The polishing workpiece is very easily broken because of uncarefully processing and efficiency of polishing process is lowered with increasing cost.

Therefore, it is needed to provide a novel and improved mounting sheet, a polishing apparatus and a method for making the same to resolve the problems mentioned above.

### SUMMARY OF THE INVENTION

The present invention provides a mounting sheet; wherein a mounting layer has different mounting areas, so that the requirements of a sufficient mounting force when polishing and easy unloading when completing polishing can be both met.

The present invention provides a mounting sheet, comprising a mounting layer; wherein the mounting layer comprises a mounting surface for mounting the substrate, and the mounting surface comprises:

a first mounting area and a second mounting area, and wherein a mounting force of the first mounting area is stronger than a mounting force of the second mounting area.

The present invention also provides a polishing apparatus comprising:
a base plate;
the mounting sheet as mentioned above adhered to the base plate; and
the substrate mounted by the mounting sheet.

The present invention further provides a method for producing the mounting sheet as mentioned above, comprising:
(a) providing a polymer sheet;
(b) providing a mold, wherein the mold comprises a first bump area and a second bump area; flatness of the first bump area differs to flatness of the second bump area, and the first bump area corresponds to the first mounting area and the second bump area corresponds to the second mounting area; and
(c) transfer printing the polymer sheet with the mold to produce the mounting sheet.

### BRIEF DESCRIPTION OF THE DRAWINGS

FIG. 1 shows a schematic view of a polishing device with a conventional mounting sheet.

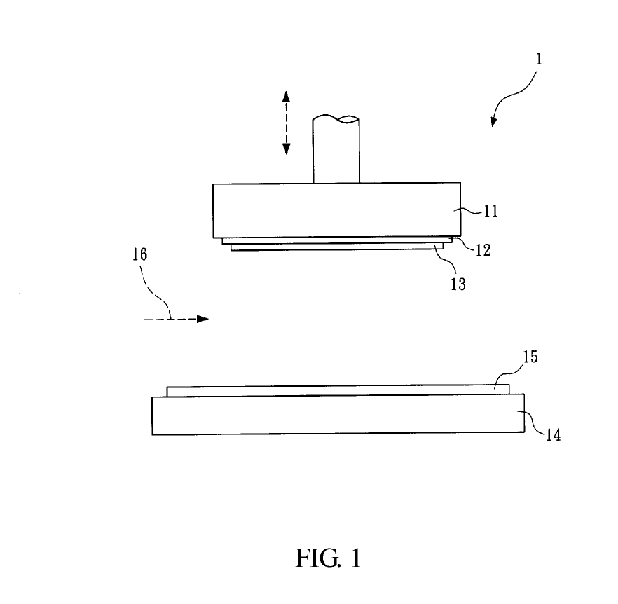

FIG. 2 shows a schematic view of a mounting surface according to a first embodiment of the invention.

FIG. 3 shows a schematic view of a mounting surface according to a second embodiment of the invention.

FIG. 4 shows a schematic view of a mounting surface according to a third embodiment of the invention.

FIG. 5 shows a schematic view of a polishing device with a mounting sheet according to the invention.

### DETAILED DESCRIPTION OF THE INVENTION

The present invention provides a mounting sheet, comprising a mounting layer; wherein the mounting layer comprises a mounting surface for mounting the substrate, and the mounting surface comprises:

a first mounting area and a second mounting area, and wherein a mounting force of the first mounting area is stronger than a mounting force of the second mounting area.

The “mounting sheet” as used herein refers to a structure for mounting, carrying and securing a substrate in the process of chemical mechanical polishing. Preferably, the mounting sheet comprises a mounting layer and the mounting layer comprises a mounting surface for mounting the substrate. The mounting sheet is preferably a sheet and able to be adhered to a polishing apparatus.

In one embodiment of the invention, a material of the mounting sheet is a polymer; preferably a foamed polymer. The material of the mounting layer may include different polymers as needed. In order to mount and secure the substrate, the material is exampled as polyurethane resin, polyvinyl chloride resin, polystyrene resin, polyethylene resin, polyamide resin, acrylic resin, or ethylene-vinyl acetate resin. Such polymers can be used independently or in combinations. Preferably, the material of the mounting layer is a foamed resin of the resin mentioned above.

The “substrate” as used herein refers to a polishing workpiece to be polished, preferably a panel. In one embodiment of the invention, the substrate is semiconductor, a storage medium substrate, an integrated circuit, an LCD flat-panel glass, an optical glass and a photoelectric panel.

The mounting surface according to the invention comprises a first mounting area and a second mounting area, and wherein a mounting force of the first mounting area is stronger than a mounting force of the second mounting area. The corresponding alignment of the first mounting area and the second mounting area may be predetermined or random.

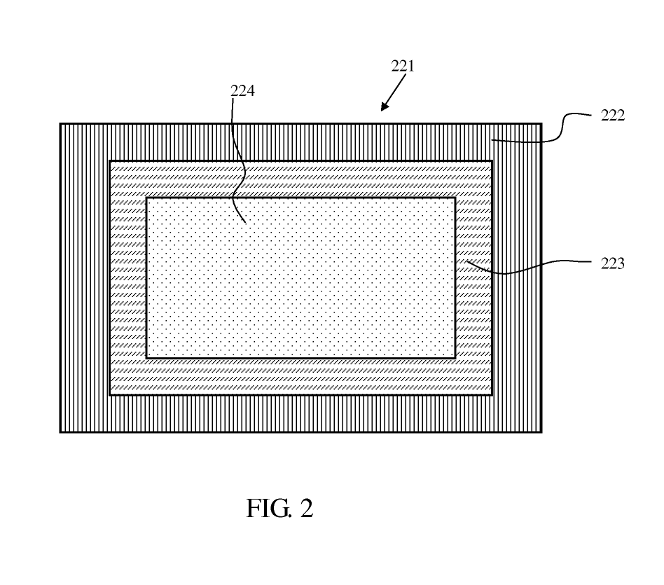

Referring to FIG. 2 showing a schematic view of a mounting surface 221 according to a first embodiment of the invention. A first mounting area 222 surrounds a second mounting area 223. Preferably, the first mounting area 222 completely surrounds the second mounting area 223. Because the first mounting area 222 positioned in a peripheral area of the mounting surface 221, a mounting force provided thereby is greater, which provides a sufficient mounting force when polishing. Parts of the substrate (not shown) mounted by the first mounting area 222 are easily unloaded because machining is easily applied thereon and a greater moment of force is achieved when applying a constant force. On the other hand, because the second mounting area 223 positioned closer to a center of the mounting surface 221, it has a less moment of force when applying the constant force. Parts of the substrate (not shown) mounted by the second mounting area 223 are still easily unloaded because the mounting force provided is less.

In one preferred embodiment of the invention, the mounting surface 221 further comprises a third mounting area 224, and the mounting force of the second mounting area 223 is stronger than a mounting force of the third mounting area 224. The combination of the first mounting area 222, second mounting area 223 and third mounting area 224 provides a more divergent and flexible alignment of mounting force; especially for a large-sized substrate, the process is more easily. The corresponding alignment of the first mounting area 222, the second mounting area 223, and the third mounting area 224 may be predetermined or random. Preferably, the second mounting area 223 surrounds the third mounting area 224; more preferably, the second mounting area 223 completely surrounds the third mounting area 224.

A shape of the first mounting area 222 or the second mounting area 223 may be random. Preferably, the shape of the first mounting area 222 or the second mounting area 223 is the same to that of the substrate. In one preferred embodiment of the invention, the shape of the first mounting area 222 or the second mounting area 223 is a square, circle or polygon. In other aspect, the first mounting area 222 and the second mounting area 223 are concentric.

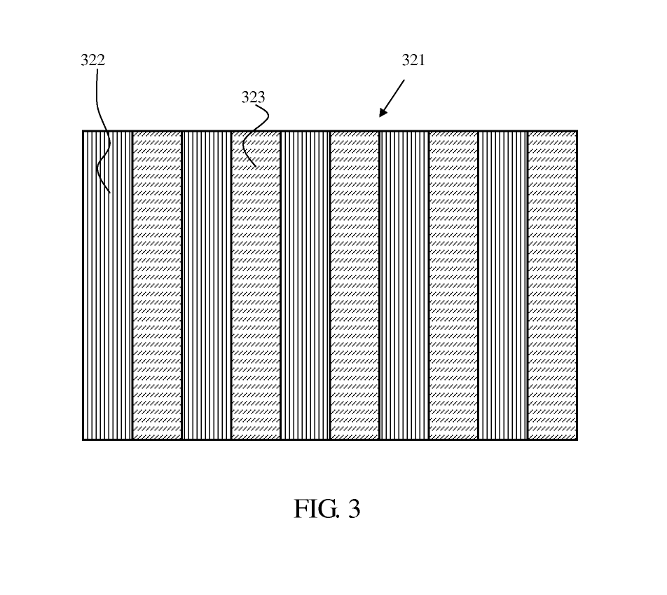

Referring to FIG. 3 showing a schematic view of a mounting surface 321 according to a second embodiment of the invention. An extending direction of the first mounting area 322 is parallel to an extending direction of the second mounting area 323. Preferably, the first mounting area 322 and the second mounting area 323 are staggered. Because a mounting force of the first mounting area 322 is greater, it provides a sufficient mounting force when polishing. On the other hand, a mounting force of the second mounting area 323 is less, parts of the substrate (not shown) mounted by the second mounting area 322 are easily unloaded. The staggered alignment meets the requirements of a sufficient mounting force when polishing and easy unloading when completing polishing.

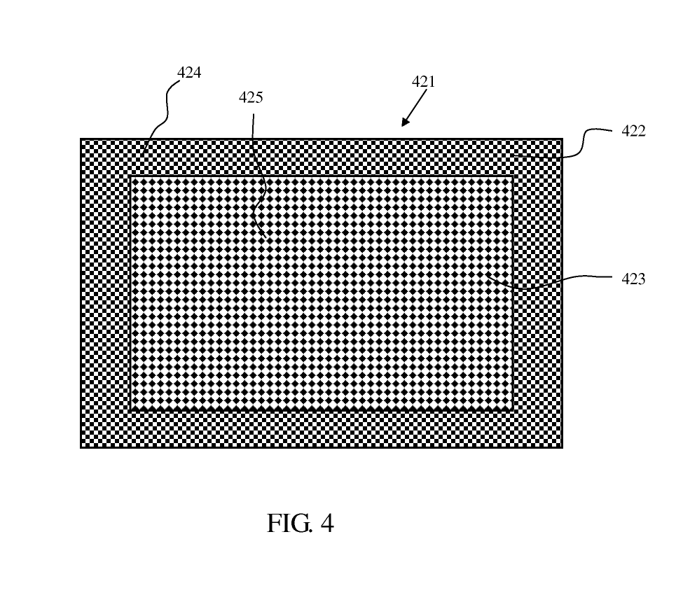

Referring to FIG. 4 showing a schematic view of a mounting surface 421 according to a third embodiment of the invention. A first mounting area 422 comprises a plurality of first mounting points 424 and a second mounting area 423 comprises a plurality of second mounting points 425. The mounting points provide a mounting force.

Difference of the mounting forces of the first mounting area and the second mounting area can be adjusted by artisans skilled in this field. In one preferred embodiment of the invention, the difference of the mounting forces of the first mounting area and the second mounting area is adjusted by adjusting flatness of the first mounting area and the second mounting area; wherein flatness of the first mounting area differs to flatness of the second mounting area.

Preferably, in order to meet the requirements of a sufficient mounting force when polishing and easy unloading when completing polishing, the mounting force of the first mounting area is greater than about 0.8 kg/cm² and the mounting force of the second mounting area is less than about 0.5 kg/cm². More preferably, the mounting force is from about 0.05 kg/cm² to about 1.3 kg/cm².

The mounting sheet of the invention preferably further comprises a buffer layer. The buffer layer comprises a plurality of continuous pores and positioned under the mount layer to provide a buffer effect of the mounting sheet when polishing. Preferably, the material of the buffer layer is exampled as polyurethane resin, polyvinyl chloride resin, polystyrene resin, polyethylene resin, polyamide resin, acrylic resin, or ethylene-vinyl acetate resin.

The present invention also provides a polishing apparatus comprising:
a base plate;
the sheet as mentioned above adhered to the base plate; and
the substrate mounted by the mounting sheet. Preferably, the polishing apparatus further comprises:
an upper base plate positioned opposite to the base plate;
a polishing pad mounted on the upper base plate for polishing the substrate; and
slurry contacting the substrate for polishing.

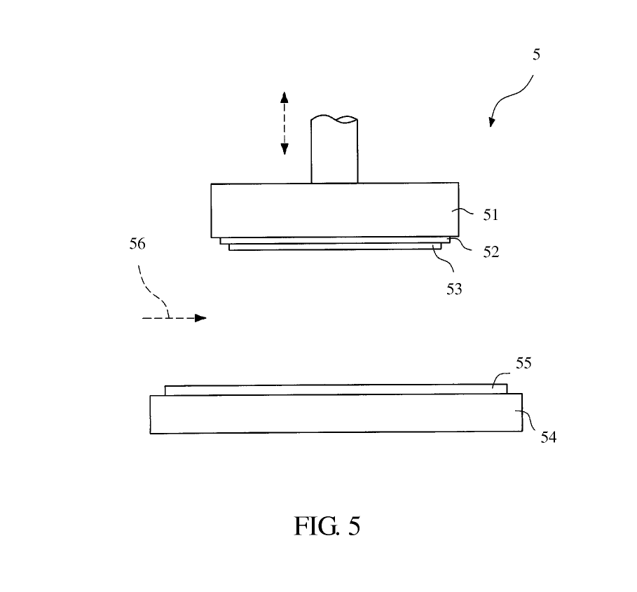

FIG. 5 shows a schematic view of a polishing device with a mounting sheet according to the invention. The polishing device 5 includes a lower base plate 51, a mounting sheet 52, a substrate 53, an upper base plate 54, a polishing pad 55 and slurry 56. The mounting sheet 52 is adhered to the lower base plate 51 through an adhesive layer 57 and is used for carrying and mounting the substrate 53. The polishing pad 55 is mounted on the upper base plate 54.

The operation mode of the polishing device 5 is as follows. First, the substrate 53 is mounted on the mounting sheet 52, and then both the upper and lower base plates 54 and 51 are rotated and the upper base plate 54 is simultaneously moved downward, such that the polishing pad 55 contacts the surface of the substrate 53, and a polishing operation for the substrate 53 may be performed by continuously supplementing the slurry 56 and using the effect of the polishing pad 55.

The present invention further provides a method for producing the sheet as mentioned above, comprising:
(a) providing a polymer sheet;
(b) providing a mold, wherein the mold comprises a first bump area and a second bump area; flatness of the first bump area differs to flatness of the second bump area, and the first bump area corresponds to the first mounting area and the second bump area corresponds to the second mounting area; and
(c) transfer printing the polymer sheet with the mold to produce the mounting sheet.

The method according to the invention, the step (a) is to provide a polymer sheet to form the mounting layer. A material of the polymer is as mentioned above.

The method according to the invention, the step (b) is using the mold to form the different flatness of the first mounting area and the second mounting area and further to provide the different mounting forces. The mold may be chosen by artisans skilled in this field, such as an ironing wheel or glossy paper. The mold comprises a first bump area and a second bump area, and the first bump area corresponds to the first mounting area and the second bump area corresponds to the second mounting area.

The method according to the invention, the step (c) is transfer printing the polymer sheet with the mold to produce the mounting sheet.

The manner of transfer printing may be chosen by artisans skilled in this field according to the mold. Preferably, the transfer printing is performed with heat.

In one preferred embodiment of the invention, when the mold is the ironing wheel, the temperature of transfer printing is from about 150° C. to about 180° C.

In one preferred embodiment of the invention, when the mold is the glossy paper, the temperature of transfer printing is from about 100° C. to about 130° C.

The following Examples are given for the purpose of illustration only and are not intended to limit the scope of the present invention.

### Example

A polymer sheet is transfer printed at 180° C. with a ironing wheel with different flatness on the surface formed by blasting. Because the different flatness of the surface of the ironing wheel, a first mounting area with a mounting force of 1.1 kg/cm² and a second mounting area with a mounting force of 0.3 kg/cm² of a mounting sheet are formed. In the 500 mm×500 mm mounting sheet, the second mounting area with a mounting force of 0.3 kg/cm² is 400 mm×400 mm, and the first mounting area with a mounting force of 1.1 kg/cm² surrounds the second mounting area. Therefore, the mounting sheet with two different mounting areas are provided.

By using a conventional mounting sheet, an average duration for replacing a substrate is about 45 seconds. On the other hand, by using the mounting sheet according to the invention, an average duration for changing a substrate is decreased to about 25 seconds. The duration is shorten for about 20 seconds, i.e. a decrease of approximately 44.4% of the replacing duration.

While embodiments of the present invention have been illustrated and described, various modifications and improvements can be made by persons skilled in the art. The embodiments of the present invention are therefore described in an illustrative but not restrictive sense. It is intended that the present invention is not limited to the particular forms as illustrated, and that all the modifications not departing from the spirit and scope of the present invention are within the scope as defined in the appended claims.

What is claimed is:

1. A mounting sheet, comprising a mounting layer; wherein the mounting layer comprises a mounting surface for mounting the substrate, and the mounting surface comprises:
a first mounting area and a second mounting area, and wherein a mounting force of the first mounting area is stronger than a mounting force of the second mounting area.

2. The mounting sheet according to claim 1, wherein the first mounting area surrounds the second mounting area.

3. The mounting sheet according to claim 1, wherein the mounting surface further comprises a third mounting area, and the mounting force of the second mounting area is stronger than a mounting force of the third mounting area.

4. The mounting sheet according to claim 3, wherein the second mounting area surrounds the third mounting area.

5. The mounting sheet according to claim 1, wherein the first mounting area and the second mounting area are concentric.

6. The mounting sheet according to claim 1, wherein an extending direction of the first mounting area is parallel to an extending direction of the second mounting area.

7. The mounting sheet according to claim 1, wherein the first mounting area comprises a plurality of first mounting points.

8. The mounting sheet according to claim 7, wherein the second mounting area comprises a plurality of second mounting points.

9. The mounting sheet according to claim 1, wherein flatness of the first mounting area differs to flatness of the second mounting area.

10. The mounting sheet according to claim 1, wherein the mounting force of the first mounting area is greater than about 0.8 kg/cm².

11. The mounting sheet according to claim 1, wherein the mounting force of the second mounting area is less than about 0.5 kg/cm².

12. The mounting sheet according to claim 1, which further comprises a buffer layer.

13. The mounting sheet according to claim 12, wherein the buffer layer comprises a plurality of continuous pores and positioned under the mount layer

13. A polishing apparatus comprising:
a base plate;
the mounting sheet as claimed in claim 1 adhered to the base plate; and
the substrate mounted by the mounting sheet.

14. The polishing apparatus according to claim 13 further comprising:
an upper base plate positioned opposite to the base plate;
a polishing pad mounted on the upper base plate for polishing the substrate; and
slurry contacting the substrate for polishing.

15. A method for producing the mounting sheet according to claim 1, comprising:
(a) providing a polymer sheet;
(b) providing a mold, wherein the mold comprises a first bump area and a second bump area; flatness of the first bump area differs to flatness of the second bump area, and the first bump area corresponds to the first mounting area and the second bump area corresponds to the second mounting area; and
(c) transfer printing the polymer sheet with the mold to produce the mounting sheet.

16. The method according to claim 15, wherein the mold is an ironing wheel or glossy paper.
